(19) United States
(12) Patent Application Publication
(10) Pub. No.: US 2024/0298322 A1
(43) Pub. Date: Sep. 5, 2024

(54) PHYSICAL UPLINK CONTROL CHANNEL ADJUSTMENT FOR PARALLEL UPLINK TRANSMISSIONS

(71) Applicant: Nokia Technologies Oy, Espoo (FI)

(72) Inventors: Matha DEGHEL, Massy (FR); Keeth Saliya Jayasinghe LADDU, Espoo (FI)

(21) Appl. No.: 18/697,909

(22) PCT Filed: Sep. 22, 2022
(86) PCT No.: PCT/EP2022/076339

§ 371 Date: Apr. 2, 2024

(30) Foreign Application Priority Data
Oct. 6, 2021 (FI) 20216032

(51) Int. Cl. H04W 72/21

(52) U.S. Cl. CPC H04W 72/21

(57) ABSTRACT

Devices, methods and computer programs for physical uplink control channel. PUCCH, transmission adjustment for parallel uplink transmissions are disclosed. A client device (200) detects a first PUCCH transmission and a parallel uplink. UL, transmission. In response to the detecting, the client device (200) adjusts at least one parameter of a PUCCH resource. The at least one parameter is related to time domain allocation and/or frequency domain allocation for the first PUCCH transmission.

### TECHNICAL FIELD

The disclosure relates generally to communications and, more particularly but not exclusively, to physical uplink control channel transmission adjustment for parallel uplink transmissions.

### BACKGROUND

Implementing a physical uplink control channel (PUCCH) transmission that is parallel or simultaneous to another uplink (UL) transmission from a user equipment (UE) with multiple transmit antenna panels is under development in fifth generation (5G) new radio (NR) wireless networks.

However, when the PUCCH transmission and the other transmission are overlapping in time, if the sum of the PUCCH transmission power and the other transmission power exceeds a maximum allowed transmit power, the UE may need to reduce the other transmission power and/or the PUCCH transmission power. When the PUCCH transmission power is reduced, PUCCH reception may be negatively impacted, e.g., when this power reduction is somewhat large.

Accordingly, at least in some situations there may be a need to find ways to avoid or at least reduce the negative impact of such PUCCH power reduction.

### SUMMARY

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

An example embodiment of a client device comprises at least one processor, and at least one memory including computer program code. The at least one memory and the computer program code are configured to, with the at least one processor, cause the client device to at least perform:
detecting a first physical uplink control channel, PUCCH, transmission and a parallel uplink, UL, transmission; and
in response to the detecting, adjusting at least one parameter of a PUCCH resource, the at least one parameter being related to at least one of time domain allocation or frequency domain allocation for the first PUCCH transmission.

In an example embodiment, alternatively or in addition to the above-described example embodiments, the parallel UL transmission comprises one of a physical uplink shared channel, PUSCH, transmission, a second PUCCH transmission, a sounding reference signal, SRS, transmission, or a physical random access channel, PRACH, transmission.

In an example embodiment, alternatively or in addition to the above-described example embodiments, the adjusting of the at least one parameter of the PUCCH resource comprises increasing a number of orthogonal frequency-division multiplexing, OFDM, symbols of the PUCCH resource.

In an example embodiment, alternatively or in addition to the above-described example embodiments, the increasing of the number of OFDM symbols of the PUCCH resource comprises adding a number of OFDM symbols, and the at least one memory and the computer program code are further configured to, with the at least one processor, cause the client device to perform receiving an indication of the number of the OFDM symbols to add via at least one of a radio resource control, RRC, parameter, a medium access control, MAC, control element, CE, or downlink control information, DCI.

In an example embodiment, alternatively or in addition to the above-described example embodiments, the DCI comprises a DCI scheduling the parallel UL transmission.

In an example embodiment, alternatively or in addition to the above-described example embodiments, the increasing of the number of OFDM symbols of the PUCCH resource comprises adding a number of OFDM symbols, and the at least one memory and the computer program code are further configured to, with the at least one processor, cause the client device to perform determining the number of the OFDM symbols to add based on a number of physical resource blocks, PRBs.

In an example embodiment, alternatively or in addition to the above-described example embodiments, the adjusting of the at least one parameter of the PUCCH resource comprises reducing a number of PRBs per OFDM symbol.

In an example embodiment, alternatively or in addition to the above-described example embodiments, the reducing of the number of the PRBs per OFDM symbol comprises reducing the number of the PRBs per OFDM symbol to be equal to a predetermined PRB threshold.

In an example embodiment, alternatively or in addition to the above-described example embodiments, the adjusting of the at least one parameter of the PUCCH resource further comprises increasing a number of OFDM symbols of the PUCCH resource by adding a number of OFDM symbols, and the at least one memory and the computer program code are further configured to, with the at least one processor, cause the client device to perform determining the number of the OFDM symbols to add as a smallest number such that encoded uplink control information, UCI, fits in the PUCCH resource.

In an example embodiment, alternatively or in addition to the above-described example embodiments, the adjusting of the at least one parameter of the PUCCH resource comprises adjusting the at least one parameter of the PUCCH resource based on a resource of the parallel UL transmission by adjusting the at least one parameter of the PUCCH resource so that time domain allocation of the PUCCH resource and time domain allocation of the resource of the parallel UL transmission have at least one of a starting symbol or an ending symbol aligned.

In an example embodiment, alternatively or in addition to the above-described example embodiments, the adjusting of the at least one parameter of the PUCCH resource comprises enabling at least one additional PUCCH repetition by overriding a first repetition factor for the PUCCH resource.

In an example embodiment, alternatively or in addition to the above-described example embodiments, the at least one memory and the computer program code are further configured to, with the at least one processor, cause the client device to perform determining the number of additional PUCCH repetitions based on a second repetition factor indicated via at least one of an RRC parameter, a MAC CE, or DCI, or based on a number of the additional PUCCH repetitions indicated via at least one of an RRC parameter, a MAC CE, or DCI.

In an example embodiment, alternatively or in addition to the above-described example embodiments, the parallel UL transmission comprises at least one of: a UL transmission in a same serving cell or same bandwidth part as the first PUCCH transmission, a UL transmission at least partially overlapping in time with the first PUCCH transmission, or a UL transmission from a different transmit antenna panel than the first PUCCH transmission.

An example embodiment of a client device comprises means for performing:
detecting a first physical uplink control channel, PUCCH, transmission and a parallel uplink, UL, transmission; and
in response to the detecting, adjusting at least one parameter of a PUCCH resource, the at least one parameter being related to at least one of time domain allocation or frequency domain allocation for the first PUCCH transmission.

In an example embodiment, alternatively or in addition to the above-described example embodiments, the parallel UL transmission comprises one of a physical uplink shared channel, PUSCH, transmission, a second PUCCH transmission, a sounding reference signal, SRS, transmission, or a physical random access channel, PRACH, transmission.

In an example embodiment, alternatively or in addition to the above-described example embodiments, the adjusting of the at least one parameter of the PUCCH resource comprises increasing a number of orthogonal frequency-division multiplexing, OFDM, symbols of the PUCCH resource.

In an example embodiment, alternatively or in addition to the above-described example embodiments, the increasing of the number of OFDM symbols of the PUCCH resource comprises adding a number of OFDM symbols, and the means are further configured to perform causing the client device to receive an indication of the number of the OFDM symbols to add via at least one of a radio resource control, RRC, parameter, a medium access control, MAC, control element, CE, or downlink control information, DCI.

In an example embodiment, alternatively or in addition to the above-described example embodiments, the DCI comprises a DCI scheduling the parallel UL transmission.

In an example embodiment, alternatively or in addition to the above-described example embodiments, the increasing of the number of OFDM symbols of the PUCCH resource comprises adding a number of OFDM symbols, and the means are further configured to perform causing the client device to determine the number of the OFDM symbols to add based on a number of physical resource blocks, PRBs.

In an example embodiment, alternatively or in addition to the above-described example embodiments, the adjusting of the at least one parameter of the PUCCH resource comprises reducing a number of PRBs per an OFDM symbol.

In an example embodiment, alternatively or in addition to the above-described example embodiments, the reducing of the number of the PRBs per OFDM symbol comprises reducing the number of the PRBs per OFDM symbol to be equal to a predetermined PRB threshold.

In an example embodiment, alternatively or in addition to the above-described example embodiments, the adjusting of the at least one parameter of the PUCCH resource further comprises increasing a number of OFDM symbols of the PUCCH resource by adding a number of OFDM symbols, and the at least one memory and the computer program code are further configured to, with the at least one processor, cause the client device to perform determining the number of the OFDM symbols to add as a smallest number such that encoded uplink control information, UCI, fits in the PUCCH resource.

In an example embodiment, alternatively or in addition to the above-described example embodiments, the adjusting of the at least one parameter of the PUCCH resource comprises adjusting the at least one parameter of the PUCCH resource based on a resource of the parallel UL transmission by adjusting the at least one parameter of the PUCCH resource so that time domain allocation of the PUCCH resource and time domain allocation of the resource of the parallel UL transmission have at least one of a starting symbol or an ending symbol aligned.

In an example embodiment, alternatively or in addition to the above-described example embodiments, the adjusting of the at least one parameter of the PUCCH resource comprises enabling at least one additional PUCCH repetition by overriding a first repetition factor for the PUCCH resource.

In an example embodiment, alternatively or in addition to the above-described example embodiments, the means are further configured to perform causing the client device to determine the number of additional PUCCH repetitions based on a second repetition factor indicated via at least one of an RRC parameter, a MAC CE, or DCI, or based on a number of the additional PUCCH repetitions indicated via at least one of an RRC parameter, a MAC CE, or DCI.

In an example embodiment, alternatively or in addition to the above-described example embodiments, the parallel UL transmission comprises at least one of: a UL transmission in a same serving cell or same bandwidth part as the first PUCCH transmission, a UL transmission at least partially overlapping in time with the first PUCCH transmission, or a UL transmission from a different transmit antenna panel than the first PUCCH transmission.

An example embodiment of a method comprises: detecting, by a client device, a first physical uplink control channel, PUCCH, transmission and a parallel uplink, UL, transmission; and
in response to the detecting, adjusting, by the client device, at least one parameter of a PUCCH resource, the at least one parameter being related to at least one of time domain allocation or frequency domain allocation for the first PUCCH transmission.

In an example embodiment, alternatively or in addition to the above-described example embodiments, the parallel UL transmission comprises one of a physical uplink shared channel, PUSCH, transmission, a second PUCCH transmission, a sounding reference signal, SRS, transmission, or a physical random access channel, PRACH, transmission.

In an example embodiment, alternatively or in addition to the above-described example embodiments, the adjusting of the at least one parameter of the PUCCH resource comprises increasing a number of orthogonal frequency-division multiplexing, OFDM, symbols of the PUCCH resource.

In an example embodiment, alternatively or in addition to the above-described example embodiments, the increasing of the number of OFDM symbols of the PUCCH resource comprises adding a number of OFDM symbols, and the method further comprises receiving, at the client device, an indication of the number of the OFDM symbols to add via at least one of a radio resource control, RRC, parameter, a medium access control, MAC, control element, CE, or downlink control information, DCI.

In an example embodiment, alternatively or in addition to the above-described example embodiments, the DCI comprises a DCI scheduling the parallel UL transmission.

In an example embodiment, alternatively or in addition to the above-described example embodiments, the increasing of the number of OFDM symbols of the PUCCH resource comprises adding a number of OFDM symbols, and the method further comprises determining, by the client device, the number of the OFDM symbols to add based on a number of physical resource blocks, PRBs.

In an example embodiment, alternatively or in addition to the above-described example embodiments, the adjusting of the at least one parameter of the PUCCH resource comprises reducing a number of PRBs per an OFDM symbol.

In an example embodiment, alternatively or in addition to the above-described example embodiments, the reducing of the number of the PRBs per OFDM symbol comprises reducing the number of the PRBs per OFDM symbol to be equal to a predetermined PRB threshold.

In an example embodiment, alternatively or in addition to the above-described example embodiments, the adjusting of the at least one parameter of the PUCCH resource further comprises increasing a number of OFDM symbols of the PUCCH resource by adding a number of OFDM symbols, and the at least one memory and the computer program code are further configured to, with the at least one processor, cause the client device to perform determining the number of the OFDM symbols to add as a smallest number such that encoded uplink control information, UCI, fits in the PUCCH resource.

In an example embodiment, alternatively or in addition to the above-described example embodiments, the adjusting of the at least one parameter of the PUCCH resource comprises adjusting the at least one parameter of the PUCCH resource based on a resource of the parallel UL transmission by adjusting the at least one parameter of the PUCCH resource so that time domain allocation of the PUCCH resource and time domain allocation of the resource of the parallel UL transmission have at least one of a starting symbol or an ending symbol aligned.

In an example embodiment, alternatively or in addition to the above-described example embodiments, the adjusting of the at least one parameter of the PUCCH resource comprises enabling at least one additional PUCCH repetition by overriding a first repetition factor for the PUCCH resource.

In an example embodiment, alternatively or in addition to the above-described example embodiments, the method further comprises determining, by the client device, the number of additional PUCCH repetitions based on a second repetition factor indicated via at least one of an RRC parameter, a MAC CE, or DCI, or based on a number of the additional PUCCH repetitions indicated via at least one of an RRC parameter, a MAC CE, or DCI.

In an example embodiment, alternatively or in addition to the above-described example embodiments, the parallel UL transmission comprises at least one of: a UL transmission in a same serving cell or same bandwidth part as the first PUCCH transmission, a UL transmission at least partially overlapping in time with the first PUCCH transmission, or a UL transmission from a different transmit antenna panel than the first PUCCH transmission.

An example embodiment of a computer program comprises instructions for causing a client device to perform at least the following:
detecting a first physical uplink control channel, PUCCH, transmission and a parallel uplink, UL, transmission; and
in response to the detecting, adjusting at least one parameter of a PUCCH resource, the at least one parameter being related to at least one of time domain allocation or frequency domain allocation for the first PUCCH transmission.

An example embodiment of a network node device comprises at least one processor, and at least one memory including computer program code. The at least one memory and the computer program code are configured to, with the at least one processor, cause the network node device to at least perform:
determining a number of orthogonal frequency-division multiplexing, OFDM, symbols for a client device to add when adjusting at least one parameter of a physical uplink control channel, PUCCH, resource; and
transmitting to the client device an indication of the number of the OFDM symbols to add via at least one of a radio resource control, RRC, parameter, a medium access control, MAC, control element, CE, or downlink control information, DCI.

An example embodiment of a network node device comprises means for performing:
determining a number of orthogonal frequency-division multiplexing, OFDM, symbols for a client device to add when adjusting at least one parameter of a physical uplink control channel, PUCCH, resource; and
causing the network node device to transmit to the client device an indication of the number of the OFDM symbols to add via at least one of a radio resource control, RRC, parameter, a medium access control, MAC, control element, CE, or downlink control information, DCI.

An example embodiment of a method comprises:
determining, by a network node device, a number of orthogonal frequency-division multiplexing, OFDM, symbols for a client device to add when adjusting at least one parameter of a physical uplink control channel, PUCCH, resource; and
transmitting, from the network node device to the client device, an indication of the number of the OFDM symbols to add via at least one of a radio resource control, RRC, parameter, a medium access control, MAC, control element, CE, or downlink control information, DCI.

An example embodiment of a computer program comprises instructions for causing a network node device to perform at least the following:
determining a number of orthogonal frequency-division multiplexing, OFDM, symbols for a client device to add when adjusting at least one parameter of a physical uplink control channel, PUCCH, resource; and
transmitting to the client device, an indication of the number of the OFDM symbols to add via at least one of a radio resource control, RRC, parameter, a medium access control, MAC, control element, CE, or downlink control information, DCI.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1 shows an example embodiment of the subject matter described herein illustrating an example system, where various embodiments of the present disclosure may be implemented;

FIG. 2A shows an example embodiment of the subject matter described herein illustrating an example client device, where various embodiments of the present disclosure may be implemented;

FIG. 2B shows an example embodiment of the subject matter described herein illustrating an example network node device, where various embodiments of the present disclosure may be implemented;

FIG. 3A illustrates a first example of implementing a PUCCH transmission adjustment operation;

FIG. 3B illustrates a second example of implementing a PUCCH transmission adjustment operation;

FIG. 3C illustrates a third example of implementing a PUCCH transmission adjustment operation;

FIG. 3D illustrates a fourth example of implementing a PUCCH transmission adjustment operation;

FIG. 3E illustrates a fifth example of implementing a PUCCH transmission adjustment operation;

FIG. 4 shows an example embodiment of the subject matter described herein illustrating a method; and

FIG. 5 shows an example embodiment of the subject matter described herein illustrating another method.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

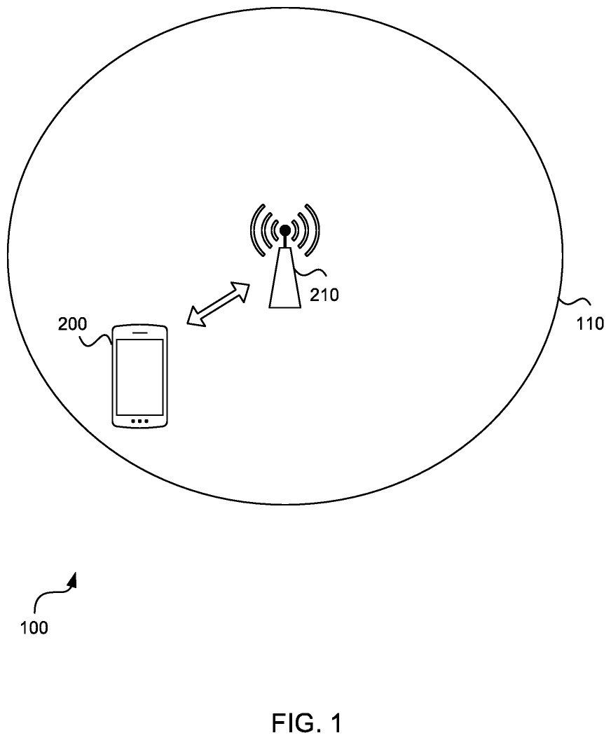

FIG. 1 illustrates an example system 100, where various embodiments of the present disclosure may be implemented. The system 100 may comprise a fifth generation (5G) new radio (NR) network 110. An example representation of the system 100 is shown depicting a client device 200 and a network node device 210. At least in some embodiments, the 5G NR network 110 may comprise one or more massive machine-to-machine (M2M) network (s), massive machine type communications (mMTC) network (s), internet of things (IoT) network (s), industrial internet-of-things (IIoT) network (s), enhanced mobile broadband (eMBB) network (s), ultra-reliable low-latency communication (URLLC) network (s), and/or the like. In other words, the 5G NR network 110 may be configured to serve diverse service types and/or use cases, and it may logically be seen as comprising one or more networks.

The client device 200 may include, e.g., a mobile phone, a smartphone, a tablet computer, a smart watch, or any hand-held, portable and/or wearable device. The client device 200 may also be referred to as a user equipment (UE). The network node device 210 may be a base station. The base station may include, e.g., a fifth-generation base station (gNB) or any such device suitable for providing an air interface for client devices to connect to a wireless network via wireless transmissions.

In the following, various concepts and terms that may be relevant to at least some example embodiments will be discussed.

Physical uplink control channel (PUCCH) in 5G NR may be used to carry uplink control information (UCI), such as a scheduling request (SR), which may also be used or dedicated for a beam failure recovery (BFR) request or a link failure recovery request (LRR), a hybrid automatic repeat request acknowledgement (HARQ-ACK), and/or channel state information (CSI).

PUCCH Format 2, 3 and 4 may carry HARQ-ACK, SR (which may be used for BFR or LRR), and/or CSI, whereas Format 0 and 1 may carry SR and/or up to two HARQ-ACK bits. Each format has a format configuration in a PUCCH configuration.

The PUCCH configuration may contain various parameters related to PUCCH. In this configuration, the client device 200 may be configured with a number of PUCCH resources.

A PUCCH resource may comprise, e.g., the following parameters:
a PUCCH resource index, used to identify the PUCCH resource,
a configuration for a PUCCH format, which may include, e.g., a number of OFDM symbols and a number of physical resource blocks (PRBs), and, for formats 1 and 4, orthogonal cover code (OCC) related parameters),
an index of a first PRB prior to frequency hopping or for no frequency hopping, and
an index of a first PRB after frequency hopping (if any).

The table below summarizes some of the characteristics of the various PUCCH formats:

| | Length | | |
|---|---|---|---|
| PUCCH | in OFDM | Number | Number |
| format | symbols | of bits | of PRBS |
| 0 | 1-2 | ≤2 | 1 |
| 1 | 4-14 | ≤2 | 1 |
| 2 | 1-2 | >2 | variable, up to 16 |
| 3 | 4-14 | >2 | variable, up to 16 |
| 4 | 4-14 | >2 | 1 |

At least in some embodiments, the client device 200 may be configured with up to four sets of PUCCH resources, where each PUCCH resource set corresponds to a certain range of UCI load. For example, PUCCH resource set 0 may handle UCI payloads of up to two bits and thus may only contain PUCCH formats 0 and 1, whereas the other PUCCH resource sets may contain any PUCCH format except formats 0 and 1.

PUCCH resource determination may depend on at least one of: a PUCCH resource indicator (PRI) in downlink control information (DCI), an UCI payload size, a first control channel element (CCE) index of a physical downlink control channel (PDCCH) carrying the DCI, a total number of CCEs in a control resource set (CORESET) on which the PDCCH carrying the DCI has been transmitted, an UCI configuration (such as SR configuration, CSI configuration, and/or semi-persistent scheduling (SPS) HARQ-ACK configuration).

For example, when the client device 200 needs to send UCI (including at least a HARQ-ACK), the PUCCH resource set may be determined based on the UCI load, and the PUCCH resource within this set may be determined using the PRI in the DCI. On the other hand, the PUCCH resources for an SR and a periodic CSI (P-CSI) may be semi-statically configured (with, e.g., radio resource control (RRC)), where the resources may be given, e.g., in the SR and CSI configurations.

PUCCH repetition operation on multiple slots for PUCCH formats 1, 3 and 4 has been defined, where an objective of the PUCCH repetition is to increase reliability and coverage for transmitted UCI. For each of these formats, the repetition operation, if enabled, comprises repeating a PUCCH carrying UCI over multiple consecutive slots. For example, for PUCCH formats 1, 3, or 4, the client device 200 may be configured via RRC with a number of slots for repetitions of a PUCCH transmission, where this number may be denoted, e.g., by N_{PUCCH}^{repeat} or by nrofSlots. The PUCCH repetition operation may be described, e.g., as follows:
the client device 200 may repeat the PUCCH transmission carrying the UCI over a preconfigured number of slots for repetition (i.e., over N_{PUCCH}^{repeat} slots),
the PUCCH repetition/transmission in each of the slots may have at least a same number of consecutive symbols and a same number of PRBs,
the PUCCH repetition/transmission in each of the slots may have a same first symbol, and
the client device 200 may be configured whether to perform or not perform frequency hopping for PUCCH repetitions/transmissions in different slots.

Multiple transmission and reception points (multi-TRPs) are in development for 5G to improve reliability, coverage, and capacity performance through flexible deployment scenarios. For example, to be able to support the exponential growth in mobile data traffic in 5G and to enhance the coverage, client devices are expected to access networks composed of multi-TRPs (i.e., macro-cells, small cells, pico-cells, femtocells, remote radio heads, relay nodes, and the like).

A TRP may be identified by at least one of the following: an SRS (sounding reference signal) resource set, a BFD-RS (beam failure detection reference signal) set, a subset/set of UL beams, a CORESETPoolIndex (if configured), or a PCI (physical cell ID).

Massive multiple-input/multiple-out (MIMO) is an enabling technology in 5G wireless communications. A large number of antenna elements may bring extra degrees of freedom for increasing throughput and beamforming gains for improving the coverage. In practice, a large number of antenna elements may be assembled into multiple antenna panels, e.g., for the purpose of cost reduction and power saving. Multi-panel MIMO is being developed, e.g., for millimeter-wave massive MIMO systems.

A multi-TRP PUCCH scheme may include at least any of the following: multi-TRP inter-slot PUCCH repetition (known as scheme 1), multi-TRP intra-slot PUCCH repetition (known as scheme 3), and/or multi-TRP PUCCH intra-slot beam hopping (known as scheme 2).

Furthermore, support of a single PUCCH resource is being developed. For example, a single PUCCH resource may be used for different (time-division multiplexed) repetitions towards different TRPs. At least in frequency range 2 (FR2), up to two spatial relation information may be indicated/activated for a PUCCH resource via a medium access control (MAC) control element (CE). At least in frequency range 1 (FR1), up to two sets of power control parameters may be indicated/activated for a PUCCH resource via a MAC CE, in which a set may include, e.g., a p0, a pathloss reference signal (RS) identification (ID), and/or a closed-loop index.

Herein, an UL beam may also refer to, e.g., spatial relation information, a separate UL transmission configuration indicator (TCI) state, a joint or common TCI state, a spatial filter, power control information or a power control parameter set, and/or an antenna panel or an antenna panel ID.

A client device antenna panel may be identified by an antenna panel ID. Alternatively or additionally, an antenna panel may be identified by or associated with at least one DL RS (or more generally an RS) or by an UL beam (s).

In the following, various example embodiments will be discussed. At least some of these example embodiments may allow PUCCH transmission adjustment for parallel UL transmissions. At least some of these example embodiments may allow avoiding or at least reducing the negative impact of PUCCH power reduction in case of parallel UL transmissions.

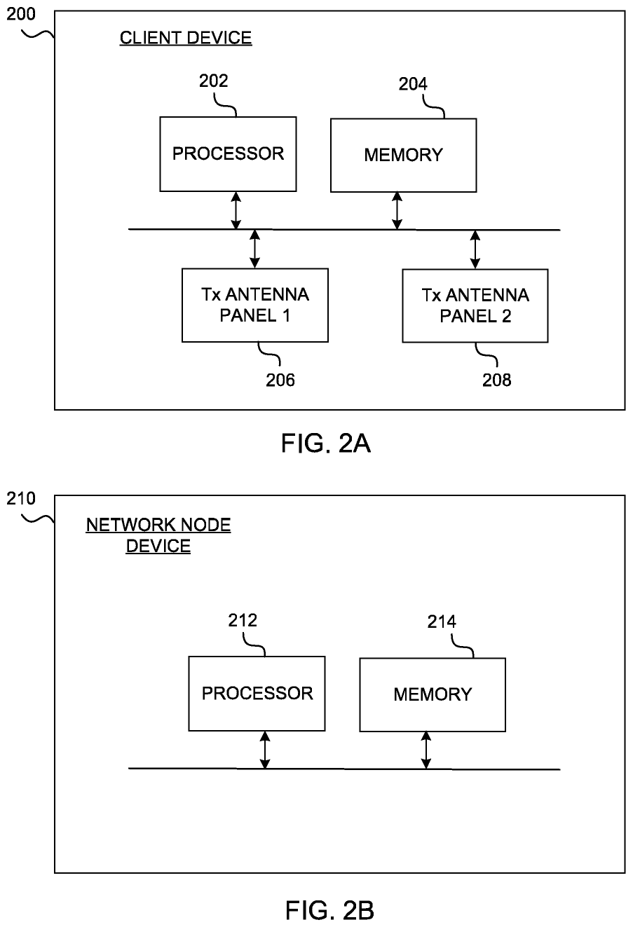

FIG. 2A is a block diagram of the client device 200, in accordance with an example embodiment.

The client device 200 comprises one or more processors 202 and one or more memories 204 that comprise computer program code. The client device 200 may further comprise a first transmit antenna panel 206 and/or a second transmit antenna panel 208. The client device 200 may also include other elements not shown in FIG. 2A, such as a transceiver configured to enable the client device 200 to transmit and/or receive information to/from other devices. In one example, the client device 200 may use the transceiver to transmit or receive signaling information and data in accordance with at least one cellular communication protocol. The transceiver may be configured to provide at least one wireless radio connection, such as for example a 3GPP mobile broadband connection (e.g., 5G). The transceiver may comprise, or be configured to be coupled to, the first transmit antenna panel 206 and/or the second transmit antenna panel 208 to transmit radio frequency signals.

Although the client device 200 is depicted to include only one processor 202, the client device 200 may include more processors. In an embodiment, the memory 204 is capable of storing instructions, such as an operating system and/or various applications. Furthermore, the memory 204 may include a storage that may be used to store, e.g., at least some of the information and data used in the disclosed embodiments.

Furthermore, the processor 202 is capable of executing the stored instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The client device 200 may comprise any of various types of devices used directly by an end user entity and capable of communication in a wireless network, such as user equipment (UE). Such devices include but are not limited to smartphones, tablet computers, smart watches, lap top computers, internet-of-things (IoT) devices, massive machine-to-machine (M2M) devices, massive machine type communications (mMTC) devices, industrial internet-of-things (IIOT) devices, enhanced mobile broadband (eMBB) devices, ultra-reliable low-latency communication (URLLC) devices, etc.

The at least one memory 204 and the computer program code are configured to, with the at least one processor 202, cause the client device 200 to at least perform detecting a first physical uplink control channel (PUCCH) transmission and a parallel uplink (UL) transmission. The term “parallel” in the parallel UL transmission indicates that the parallel UL transmission may comprise at least one of: a UL transmission in a same serving cell or same bandwidth part as the first PUCCH transmission, a UL transmission at least partially overlapping in time with the first PUCCH transmission, or a UL transmission from a different transmit antenna panel than the first PUCCH transmission, and/or a UL transmission using different spatial relation information, UL beams, power control parameters set, and/or UL TCI state than the first PUCCH transmission. For example, the parallel UL transmission may comprise a physical uplink shared channel (PUSCH) transmission, a second PUCCH transmission, a sounding reference signal (SRS) transmission, or a physical random access channel (PRACH) transmission.

The at least one memory 204 and the computer program code are further configured to, with the at least one processor 202, cause the client device 200 to perform adjusting, in response to the detecting, at least one parameter of a PUCCH resource. The at least one parameter is related to time domain allocation and/or frequency domain allocation for the first PUCCH transmission.

In other words, the client device 200 may adjust one or more PUCCH resource parameters related to at least time and/or frequency domain allocation for a PUCCH transmission (e.g., based on a configuration and/or an indication and/or a rule by the network node 210), where this adjustment operation may be applied on a corresponding initially indicated/configured PUCCH resource, and it may be conditional to at least having parallel PUCCH and PUSCH transmissions (case-1), or a parallel PUCCH transmission and another PUCCH transmission (case-2), or a parallel PUCCH transmission and an SRS transmission (case-3), or a parallel PUCCH transmission and a PRACH transmission.

In at least some embodiments (embodiments A), the adjusting of the at least one parameter of the PUCCH resource may comprise increasing a number of orthogonal frequency-division multiplexing (OFDM) symbols of the PUCCH resource.

The increasing of the number of OFDM symbols of the PUCCH resource may comprise adding a number of OFDM symbols, and the at least one memory 204 and the computer program code may further be configured to, with the at least one processor 202, cause the client device 200 to perform receiving an indication of the number of the OFDM symbols to add via at least one of a radio resource control (RRC) parameter, via a medium access control (MAC) control element (CE), or via downlink control information (DCI). The DCI may comprise a DCI scheduling the parallel UL transmission.

Alternatively/additionally, the increasing of the number of OFDM symbols of the PUCCH resource may comprise adding a number of OFDM symbols, and the at least one memory 204 and the computer program code may further be configured to, with the at least one processor 202, cause the client device 200 to perform determining the number of the OFDM symbols to add based on a number of physical resource blocks (PRBs).

In other words, in embodiments A the adjustment operation for PUCCH may include extending the PUCCH resource in the time domain (after the last symbol) by increasing its number of OFDM symbols.

The number of symbols to add may be indicated, e.g., via RRC or via MAC CE. The PUCCH resource (or corresponding PUCCH format or set/group of PUCCH resources) may be associated (e.g., via RRC or MAC CE) with a number of additional symbols to add when the adjustment operation is applicable. Hence, when the client device 200 determines or is indicated to use this PUCCH resource, the client device 200 may know the number of additional symbols to add in case of adjustment operation. Alternatively, the PUCCH resource (or corresponding PUCCH format or set/group of PUCCH resources) may be associated (e.g., via RRC or MAC CE) with a second or dedicated (total) number of symbols to use when the adjustment operation is applicable. Hence, when the client device 200 determines or is indicated to use this PUCCH resource, the client device 200 may know the (total) number of symbols to use in the adjustment operation.

In at least some embodiments, the number of symbols to add (which may be greater than or equal to zero) may be dynamically indicated via DCI, such as DCI scheduling PUSCH overlapping with the PUCCH (or DCI (re-) activating CG PUSCH Type 2, or triggering SRS, or triggering CSI reporting, or DCI scheduling another PUCCH, etc.), using a new DCI field or an existing DCI field (e.g., by re-interpreting a beta offset indicator, or via a TDRA/FDRA (time/frequency domain resource allocation) indication). For example, the client device 200 may be indicated via DCI the number of additional symbols (e.g., from a configured set of values) to add when the adjustment operation is applicable to the PUCCH resource. Alternatively, the PUCCH resource (or corresponding PUCCH format or set/group of PUCCH resources) may be associated (e.g., via RRC or MAC CE) with at least two (total) numbers of symbols, and the client device 200 may be indicated via DCI which number to use for the adjustment operation.

In at least some embodiments, whether to extend the PUCCH resource and/or how many symbols to add may depend on the number of PRBs. This may be applicable, e.g., to PUCCH formats 2 and 3. Specifically, if the number of PRBs is greater than (or equal to) a predefined threshold, the client device 200 may add a configured number of symbols. This may be generalized by defining several intervals of numbers of PRBs (by defining corresponding thresholds), and each interval may be associated to a number of symbols to add.

At least for PUCCH formats with a client device multiplexing capacity (such as formats 1 and 4), an OCC (Orthogonal Cover Code) different than an initial OCC and corresponding to the total number of symbols after adjustment may be configured and used.

The indicated or configured number of symbols to add may be defined as a percentage (or ratio) of the initial PUCCH resource. A ceiling or floor operation may also be defined in this case if needed. For example, for an initial PUCCH resource with four symbols, an increase of 50% in the number of symbols may be indicated or configured for the adjustment operation, in which case two symbols may be added and thus the resulting (or adjusted) PUCCH resource may have six symbols.

The number of PRBs may be determined considering the initial number of symbols or the number of symbols after adjustment.

In at least some embodiments (embodiments B), the adjusting of the at least one parameter of the PUCCH resource may comprise reducing a number of PRBs per an OFDM symbol (e.g., to be equal to a predetermined PRB threshold). In these embodiments, the adjusting of the at least one parameter of the PUCCH resource may further comprise increasing a number of OFDM symbols of the PUCCH resource. In these embodiments, the increasing of the number of OFDM symbols of the PUCCH resource may comprise adding a number of OFDM symbols, and the at least one memory 204 and the computer program code may further be configured to, with the at least one processor 202, cause the client device 200 to perform determining the number of the OFDM symbols to add as a smallest number such that encoded uplink control information (UCI) fits in the PUCCH resource.

In other words, in embodiments B the adjustment operation for PUCCH may include shrinking the PUCCH resource in the frequency domain (e.g., starting from the PRB with lowest/highest index), and additionally the PUCCH resource may be extended in the time domain (after the last symbol) by increasing its number of OFDM symbols based on the following.

Given a threshold on the number of PRBs per symbol, if the number of PRBs is greater than this threshold, then the PUCCH resource may be extended by adding a number of symbols. The total number of symbols after adjustment in this case may be defined as the total number of PRBs (considering the initial number of symbols) divided by the PRB threshold-if the resulting total number of symbols is not an integer, this number may be rounded up to the lowest integer greater (or lower) than this number. The number of symbols to add may be the resulting total number of symbols minus the initial number of symbols. In addition, the number of PRBs (per symbol) may be reduced to be equal to the PRB threshold.

The above operation may be illustrated mathematically as follows: Let N^{thr} be the configured/defined PRB threshold, N_{RB} be the number of PRBs, and N_{sym} be the number of symbols for the initial PUCCH resource. In this example, the total number of PRBs (considering the entire PUCCH allocation) is N_{RB}*N_{sym} (where * is the multiplication operation). If N_{RB}>N^{thr}, the adjusted total number of symbols may be determined as Ceiling (N_{RB}*N_{sym}/N^{thr}). E.g., a Floor operator may be used instead of the Ceiling operator.

The PRB threshold may be configured per PUCCH resource (or PUCCH format or set/group of PUCCH resources). Alternatively, a PUCCH resource (or PUCCH format or set/group of PUCCH resources) may be associated with at least two PRB thresholds, and the client device 200 may consider the closest threshold lower than the (initial) number of PRBs. Alternatively, a PUCCH resource (or PUCCH format or set/group of PUCCH resources) may be associated with at least two PRB thresholds, and the client device 200 may be indicated the PRB threshold to use via DCI, such as DCI scheduling PUSCH overlapping with the PUCCH (or (re-)activating CG PUSCH Type 2, or triggering SRS, or triggering CSI reporting, DCI scheduling another PUCCH, etc.), using a new DCI field or an existing DCI field (e.g., by re-interpreting the beta offset indicator, or via a TDRA/FDRA (time/frequency domain resource allocation) indication).

In at least some embodiments, the number of symbols to add may be indicated or configured (or determined) based on the ways listed under embodiments A.

In at least some embodiments, the number of symbols may be determined as follows: considering a PRB threshold (or the number of PRBs), maxCodeRate, UCI payload size, and a PUCCH format, the number of symbols may be determined as the smallest number, such that the encoded UCI fits in the PUCCH resource.

The above operation may be illustrated mathematically as follows: Let N^{thr} be the configured/defined PRB threshold (or the number of PRBs), r be the maxCodeRate, O_{uci} be the UCI payload size, Qₘ to depend on the modulation (Qₘ=1 in case of pi/2-BPSK and Qₘ=2 in case of QPSK), and N_{sc} be the number of subcarriers in a PRB (or RB). The number of symbols N_{symb} (which may exclude demodulation reference signal (DMRS) symbols, depending on the PUCCH format) may be determined as the smallest number (integer less than 14 or less than a given threshold, and/or greater than a threshold), such that:

O_{uci}≤N^{thr}*N_{sc}*Oₘ*r*N_{symb}.

The (determined) number of symbols may need to be greater than (or equal to) a given threshold, where this threshold may be configured per PUCCH format (or PUCCH resource or set/group of resources). Also, the (determined) number of symbols may need to be lower than (or equal to) a given threshold, where this threshold may be configured per PUCCH format (or PUCCH resource or set/group of resources).

In at least some embodiments (embodiments C), the adjusting of the at least one parameter of the PUCCH resource may comprise adjusting the at least one parameter of the PUCCH resource based on a resource of the parallel UL transmission. In these embodiments, the adjusting of the at least one parameter of the PUCCH resource based on the resource of the parallel UL transmission may comprise adjusting the at least one parameter of the PUCCH resource so that time domain allocation of the PUCCH resource and time domain allocation of the resource of the parallel UL transmission have at least one of a starting symbol or an ending symbol aligned.

In other words, in embodiments C the adjustment operation for PUCCH may include using a full overlapping PUCCH resource in the time domain as PUSCH. The PUCCH resource may be adjusted depending at least partially on the resource of the overlapping uplink transmission such a PUSCH (or another PUCCH, or SRS, or PRACH).

The PUCCH resource may be adjusted so that the time domain allocation of this PUCCH resource and of the overlapping PUSCH (or another PUCCH, or SRS, or PRACH) have at least one of the starting symbol or ending symbol aligned.

If due to the above adjustment operation, the preparation time for UCI carried in the PUCCH would become less than a certain threshold (such as PDSCH to HARQ feedback timing indicated in DCI), the client device 200 may drop one of the overlapping transmissions or may move one of them (in time) in such a way that there would be no overlap (in time) between these transmissions.

The number of PRBs may be changed based on any of the above discussed ways for embodiments B.

In at least some embodiments (embodiments D), the adjusting of the at least one parameter of the PUCCH resource may comprise enabling at least one additional PUCCH repetition. In these embodiments, the enabling of the at least one additional PUCCH repetition may comprise overriding a first repetition factor for the PUCCH resource. In these embodiments, the at least one memory 204 and the computer program code may further be configured to, with the at least one processor 202, cause the client device 200 to perform determining the number of additional PUCCH repetitions based on a second repetition factor indicated via at least one of an RRC parameter, a MAC CE, or DCI, or a number of the additional PUCCH repetitions indicated via at least one of an RRC parameter, a MAC CE, or DCI.

In other words, in embodiments D the adjustment operation for PUCCH may include enabling at least one additional PUCCH repetition by overriding the initially indicated/configured PUCCH repetition factor r for the initial PUCCH resource (i.e., before the adjustment operation).

The PUCCH resource (or corresponding PUCCH format or set/group of PUCCH resources) may be configured (e.g., via RRC) with at least one second repetition factor (also referred to, e.g., as nrofSlots or nrofsubSlots), or with at least one number of additional PUCCH repetition (s), to use for the adjustment operation. The second repetition factor may be larger than or equal to one. Hence, when the client device 200 determines or is indicated to use this PUCCH resource, the client device 200 may know the repetition factor to use in case of adjustment operation.

In at least some embodiments, to override the first repetition factor (used for the case without a PUCCH adjustment operation), the PUCCH repetition factor may be dynamically indicated via DCI, such as DCI scheduling PUSCH overlapping with the PUCCH (or (re-)activating CG PUSCH Type 2, or triggering SRS, or triggering CSI reporting, DCI scheduling another PUCCH, etc.), using a new DCI field or an existing DCI field (e.g., by re-interpreting the beta offset indicator, or via a TDRA/FDRA (time/frequency domain resource allocation) indication). Specifically, the PUCCH resource (or corresponding PUCCH format or set/group of PUCCH resources) may be associated with at least two repetition factors and the client device 200 may be indicated, e.g., via DCI scheduling PUSCH overlapping with the PUCCH which repetition factor to use for the adjustment operation. Alternatively, the client device 200 may be indicated the additional number of PUCCH repetitions (i.e., a sort of offset) to use for the adjustment operation. This number may be greater than or equal to zero. In this case, to determine the PUCCH repetition factor for the adjustment operation, the indicated number of additional PUCCH repetitions may be added to the first repetition factor.

Regarding the position of additional PUCCH repetition (s), the additional PUCCH repetition (s) may be added considering a sub-slot or slot granularity. Specifically, in case of sub-slot/slot granularity, a PUCCH repetition may be added in each sub-slot/slot. A sub-slot may be of two symbols or seven symbols. Whether to use sub-slot or slot granularity may be inferred from whether the PUCCH configuration to which the indicated/configured PUCCH resource belongs is a sub-slot-based or slot-based PUCCH configuration. Alternatively, even if the corresponding PUCCH configuration is slot-based, a specific field may be used to indicate whether for the PUCCH adjustment operation the client device 200 may use slot granularity or sub-slot granularity. Also, the sub-slot granularity may be configured (as two or seven symbols). Alternatively, the client device 200 may be indicated via DCI (such as DCI scheduling UL transmission) whether to use slot or sub-slot granularity.

In at least some embodiments for the position of additional PUCCH repetition (s), a sub-slot or slot may not be considered to include such a PUCCH repetition if overlaps a this PUCCH repetition with PUSCH/PUCCH/SRS/PRACH overlapping with at least some of the initial PUCCH repetition (s) (i.e., before adjustment).

At least some of the following may apply to the adjusted PUCCH resource, or more generally the adjusted PUCCH transmission, based on increasing the number of symbols (i.e., embodiments A, embodiments B, embodiments C above):
the encoded UCI bits (e.g., in case of PUCCH formats 2/3/4) may be mapped over the entire adjusted PUCCH resource (except the DMRS resources);
in some cases, e.g., for PUCCH format 0/2, the client device 200 may be configured to repeat the content of at least one of the initial number of symbols (i.e., before adjustment) in the added symbols. For example, for a PUCCH resource with format 2 initially with two symbols, considering adding two other symbols based on embodiments A, the encoded UCI bits may be mapped to the first two symbols, and then the content of these symbols may be repeated in the next two added symbols. As another example, for a PUCCH resource with format 0 initially with two symbols, considering adding two other symbols based on embodiments A, the sequence which is mapped to the first symbol and the content of the first symbol may be repeated in the second symbol, and then the content of the first symbol may also be repeated in each of the two added symbols. Alternatively, a different cyclic shift (corresponding to a phase rotation in the frequency domain) may be used for each of the two added symbols or at least one of these two symbols. In this case, an offset may be defined between the two cyclic shift/phase rotation values;
in some cases, e.g., for PUCCH format 1, the client device 200 may be configured to map the modulated sequence over the adjusted PUCCH resource (except the DMRS resources).

For embodiments A and embodiments B (and embodiments C), an upper bound may be defined to limit the number of symbols to add. This upper bound may be configured, e.g., via RRC per PUCCH resource (or PUCCH format or set/group of PUCCH resources).

For at least some of the above discussed embodiments, the adjustment operation may be enabled/disabled by the network node device 210 via RRC, a new or an existing MAC CE, and/or a new or an existing DCI field. For example, the indication for enabling/disabling may be indicated via DCI scheduling PUSCH overlapping with the PUCCH (or (re-)activating CG PUSCH Type 2, or triggering SRS, or triggering CSI reporting, DCI scheduling another PUCCH, etc.) using a new DCI field or an existing DCI field (e.g., by re-interpreting the beta offset indicator). As another example, the DCI corresponding to the PUCCH may be used to carry the indication on enabling/disabling the PUCCH adjustment operation.

For at least some of the embodiments, in addition/alternative to an indication from the network node device 210 to the client device 200, the number of OFDM symbols to add (or a second or dedicated (total) number of symbols), and/or the number of PRBs to shrink, and/or the second repetition factor/number of additional repetitions, and/or any other parameter to be indicated in at least some of the above discussed embodiments may be predefined/agreed on (e.g., via 3GPP specifications) at both the network node device 210 and the client device 200. In this case, signaling may not be needed between the network node device 210 and the client device 200.

For at least some of the above discussed embodiments, when the PUCCH and PUSCH transmissions are intended to be received at different TRPs, an additional level of coordination signalling may be used to determine the adjustment operation performed by the client device 200. For example, if DCI sent by TRP1 schedules a PUSCH transmission and DCI sent by TRP2 schedules a PUCCH transmission and results in an adjustment operation due to overlapping resources, the TRP1 may indicate the scheduling parameters of PUSCH towards the TRP2 such that TRP2 understands the possibility of the client device 200 adjusting the PUCCH transmission. In at least some embodiments, such scheduling parameters of PUSCH may be sent towards TRP2 as soon as PUSCH scheduling parameters are decided by the TRP1.

In the case of PUCCH repetition operation, the adjustment operation may be applicable to all PUCCH repetitions or to a subset of repetitions, such as only to the repetitions that overlap (in time) with PUSCH and/or (another) PUCCH or SRS. If more than one PUCCH repetition overlaps with a PUSCH/PUCCH, the adjustment operation discussed above may be configured to be applied only once or to be applied multiple times.

Considering the adjusted PUCCH resource, or more generally the adjusted PUCCH transmission, based on increasing the number of symbols (i.e., embodiments A, embodiments B, embodiments C above): DMRS positions and ratio (compared to data) may be determined based on existing specifications considering the total number of symbols after adjustment.

For at least embodiments B (and embodiments A), the granularity in the frequency domain may be a PRB/RB set (or subset) instead of PRB/RB. In this case, the PRB threshold and/or the number of RBs may be expressed in units of PRB sets (instead of PRB).

An additional way or aspect for adjusting the PUCCH may be to override the PUCCH resource. For instance, an overriding PRI or at least a PRI offset (e.g., to add or subtract from the initial PRI) may be indicated via DCI scheduling PUSCH overlapping with the PUCCH (or (re-)activating CG PUSCH Type 2, or triggering SRS, or triggering CSI reporting, DCI scheduling another PUCCH, etc.) using a new DCI field or an existing DCI field (e.g., by re-interpreting the beta offset indicator, or via a TDRA/FDRA (time/frequency domain resource allocation) indication). In this case, the client device 200 may use the new/updated PRI to determine a potentially new PUCCH resource to use for the PUCCH transmission/repetition. At least in some embodiments, at least one PUCCH resource may be configured to be used instead of the initial PUCCH resource in case of overlap between PUCCH and another UL transmission. The new PUCCH resource may be selected based on criteria related to the overlapping UL transmission, such as the PUSCH resource (e.g., time domain allocation for this PUSCH).

Although the adjustment operation is defined in case of overlapping PUCCH and PUSCH/PUCCH/SRS/PRACH transmissions, this adjustment may also be used in other scenarios, such as in case of a maximum permissible exposure (MPE) event or a coverage limited scenario. Also, for these scenarios, the decision whether to apply the adjustment operation or not may be left up to the client device 200, or it may be at least partially controlled by the network node device 210.

Since, e.g., the power reduction operation may be at least partially up to the client device 200 implementation, the adjustment decision may be left up to the client device 200 which then may indicate to the network node device 210 whether adjustment has been applied or not. In this case, this indication may be carried via (i) dedicated DMRS information (e.g., in case adjustment has been applied), such as a dedicated DMRS sequence or a dedicated orthogonal cover code (OCC) for DMRS or dedicated time (and/or frequency) resources for DMRS, for PUCCH/PUSCH or (ii) UCI separately encoded and included in the PUCCH/PUSCH. The decision whether to apply the adjustment operation may depend on whether the PUCCH power reduction occurs or whether the PUCCH power reduction is larger than a preconfigured offset or below a preconfigured threshold. For example, at least two power thresholds (first and second threshold, where the first threshold is greater than the second threshold) may be configured (which may be defined as absolute values or as a percentage of the PUCCH power before power reduction), which form three intervals, and the number of symbols to add (and/or the number of PRBs, and/or an additional number of PUCCH repetitions) may be determined as follows: if the PUCCH power after power reduction is above the first threshold, then no adjustment is applied; if the PUCCH power after power reduction is below or equal to the first threshold and above the second threshold, then adjustment operation is applied considering, e.g., a number of symbols to add (and/or a number of PRBs to reduce, and/or an additional number of PUCCH repetitions to add) corresponding to the interval between the first and second thresholds; if the PUCCH power after power reduction is below or equal to the second threshold, then adjustment operation is applied considering, e.g., a number of symbols to add (and/or a number of PRBs to reduce, and/or an additional number of PUCCH repetitions to add) corresponding to the interval below the second threshold.

In case of (intra-slot) frequency hopping for PUCCH, at least some of the above discussed embodiments may apply per PUCCH hop instead of per PUCCH resource. For instance, if only one PUCCH hop overlaps with another UL transmission, under embodiments D the at least one additional repetition may apply only for that hop.

The term parallel in “parallel UL transmissions” may correspond to having the UL transmissions (or the corresponding resources) overlapping fully or partially in time. In some embodiments, if one of the UL transmissions is a PRACH transmission, the term “parallel” or “overlap” may not necessarily mean that the PRACH transmission and the other UL transmission are overlapping in time—it may mean that the PRACH and UL transmission are in the same slot or are at most a number of symbols distant from each other (in the time domain). Further, the parallel UL transmissions may be in the same serving cells or bandwidth part (or in different serving cells or bandwidth part). E.g., in case when a supplementary uplink (SUL) is configured, the parallel UL transmissions may be in the same carrier or in different carriers (in the same cell). The parallel UL transmissions may be in the same cell or in cells having different physical cell ID.

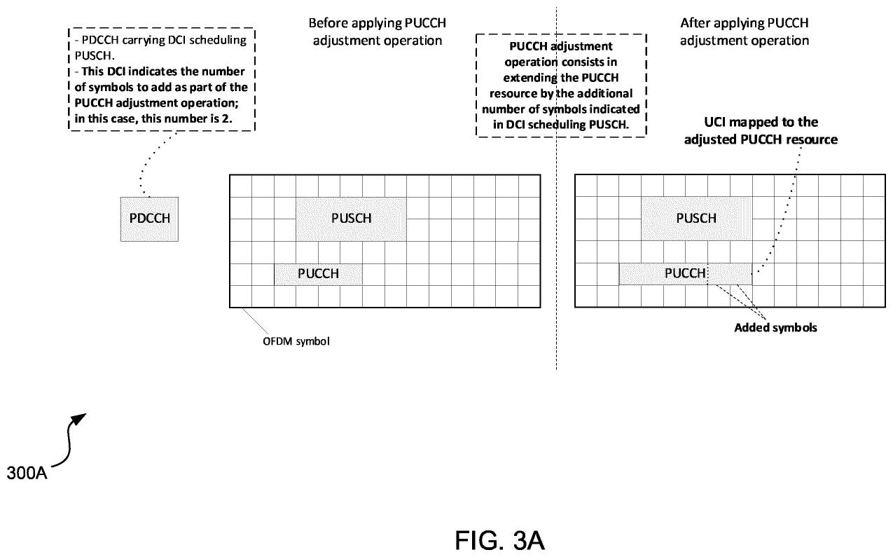

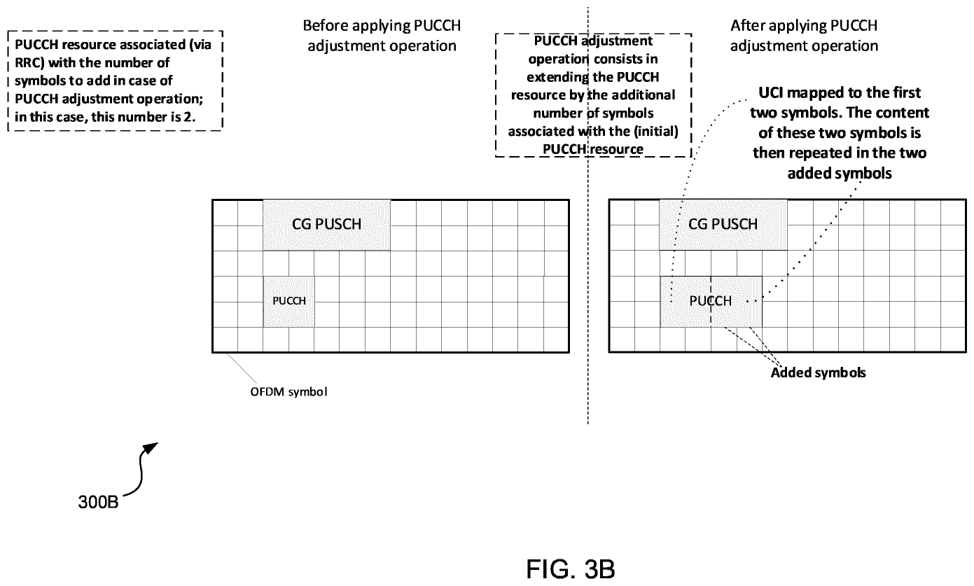

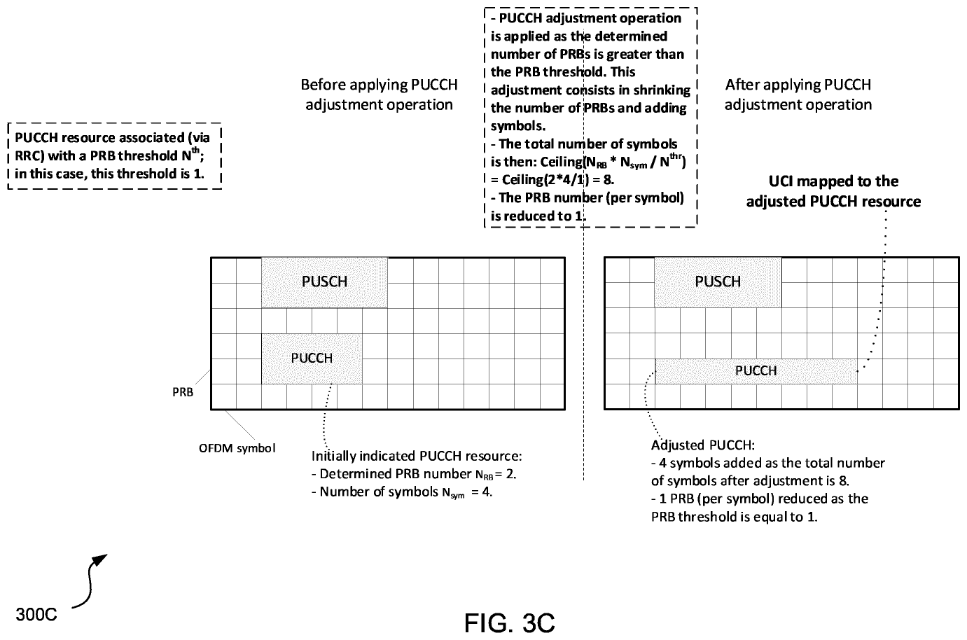

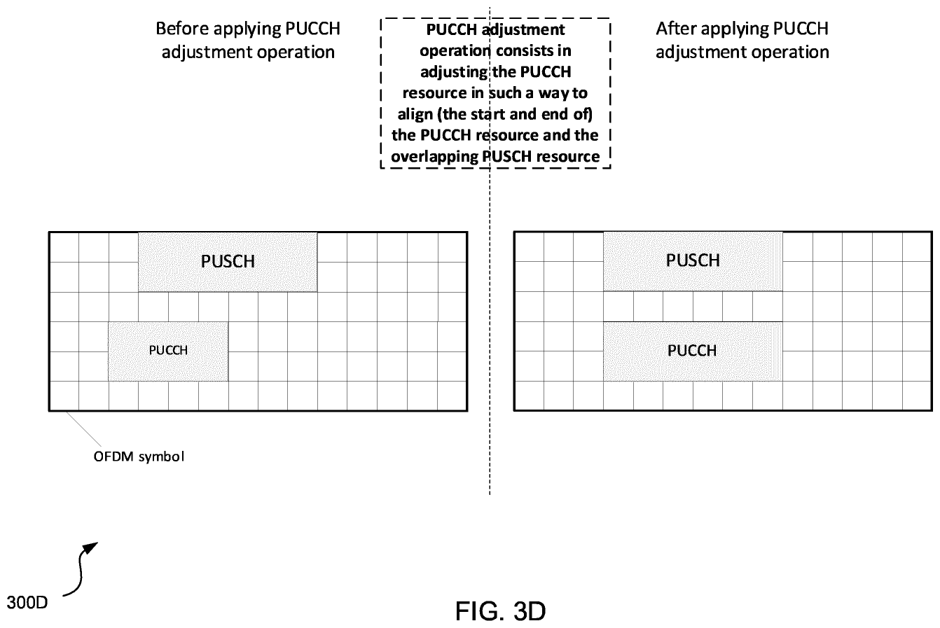

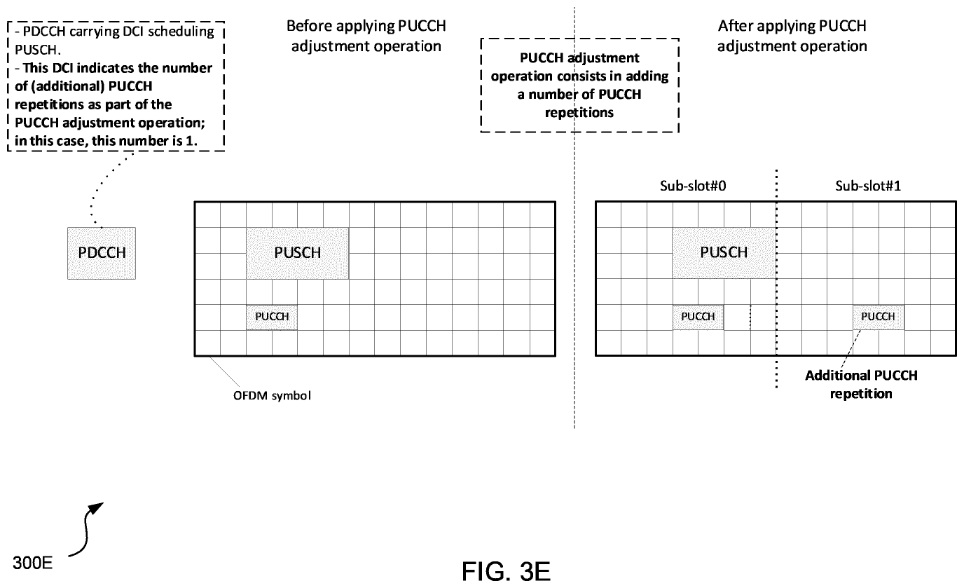

Diagram 300A of FIG. 3A provides an example illustrating the embodiments A. In this example, a PDCCH carries DCI scheduling PUSCH where this PUSCH overlaps with (a dynamically scheduled or configured) PUCCH. The initial PUCCH resource is of four (OFDM) symbols, i.e., a long PUCCH format such as format 1, 3 or 4.

Under embodiments A, as one of the variants, the PUCCH adjustment operation due to the overlap with the scheduled PUSCH may comprise extending the PUCCH resource by an additional number of symbols indicated in the DCI scheduling the PUSCH. In FIG. 3A, this indicated number of symbols is two. Hence, as shown in FIG. 3A, after the adjustment operation the PUCCH resource is extended by two symbols, i.e., the adjusted PUCCH resource length becomes six symbols. If the PUCCH is of a format with a variable number of PRBs, the client device 200 may then determine the number of PRBs based on the extended PUCCH length. In this example, the (encoded) UCI is mapped to the entire adjusted PUCCH resource.

Diagram 300B of FIG. 3B provides another example illustrating the embodiments A. In this example, a CG (configured grant) PUSCH overlaps with (a configured) PUCCH. The initial PUCCH resource is of two (OFDM) symbols, i.e., a short PUCCH format, such as format 0 or 2.

Under embodiments A, as one of the variants, the PUCCH adjustment operation (due to the overlap with the scheduled PUSCH) may comprise extending the PUCCH resource by the additional number of symbols associated with the (initial) PUCCH resource, where the association is provided via RRC (or MAC CE). In FIG. 3B, this indicated number of symbols is two. Hence, as shown in FIG. 3B, after the adjustment operation the PUCCH resource is extended by two symbols, i.e., the adjusted PUCCH resource length becomes six symbols. If the PUCCH is of a format with a variable number of PRBs, the client device 200 may then determine the number of PRBs based on the extended PUCCH length. In this example, the (encoded) UCI is mapped to the first two symbols of the adjusted PUCCH resource, and the content of these two symbols is then repeated in the two added symbols.

Diagram 300C of FIG. 3C provides another example illustrating the embodiments B. In this example, a PUSCH overlaps with PUCCH. The initial PUCCH resource is of four (OFDM) symbols, i.e., a long PUCCH format, such as format 1, 3 or 4.

Under embodiments B, as one of the variants, the PUCCH adjustment operation (due to the overlap with the PUSCH) may comprise shrinking the PUCCH resource in the frequency domain and extending the PUCCH resource in the time domain by increasing its number of OFDM symbols. In this example, the PUCCH adjustment operation may be applied as the number of PRBs is greater than the PRB threshold, where the PUCCH resource is associated (e.g., via RRC or MAC CE) with the PRB threshold N^{thr}. In this example, this threshold is equal to one. The total number of symbols due to the adjustment may be calculated as follows: Ceiling (N_{RB}*N_{sym}/N^{thr})=Ceiling (2*4/1)=8. The PRB number (per symbol) may be reduced to one so that it is equal to N^{thr}.

Therefore, the PUCCH adjustment operation may comprise: (i) four symbols added as the total number of symbols after adjustment is 8, and (ii) one PRB (per symbol) reduced as the PRB threshold is equal to one.

Diagram 300D of FIG. 3D provides an example illustrating the embodiments C. In this example, a PUSCH overlaps with PUCCH. The initial PUCCH resource is of four (OFDM) symbols, i.e., a long PUCCH format, such as format 1, 3 or 4.

Under embodiments C, as one of the variants, PUCCH adjustment operation may comprise adjusting the PUCCH resource in such a way as to align (the start and end of) the PUCCH resource and the overlapping PUSCH resource.

Diagram 300E of FIG. 3E provides an example illustrating the embodiments D. In this example, a PUSCH overlaps with PUCCH. The initial PUCCH resource is of two (OFDM) symbols, i.e., a short PUCCH format, such as format 0 or 2. The number of PUCCH transmission/repetition initially configured/indicated is one.

Under embodiments D, PUCCH adjustment operation comprises adding a number of PUCCH repetitions. As one possibility, the DCI scheduling the PUSCH may indicate the number of additional PUCCH repetitions for the adjustment operation. In this example, this number is one. Hence, due to the adjustment operation, an additional PUCCH repetition is added, as shown in FIG. 3E. A granularity of sub-slot (of 7-symbol length) is assumed for the PUCCH repetition operation, i.e., added PUCCH repetition is over sub-slot granularity.

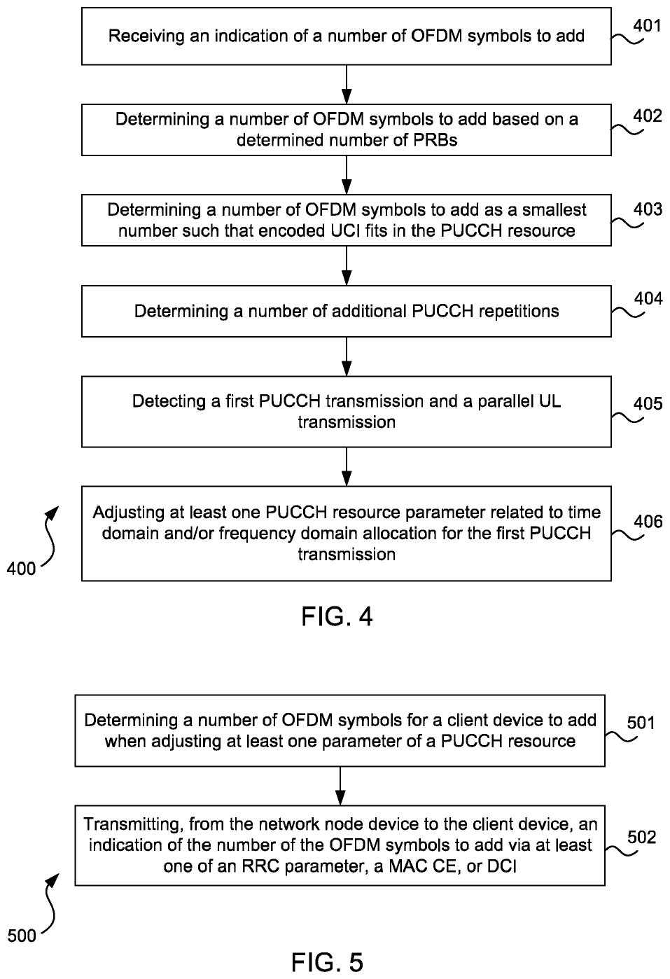

FIG. 4 illustrates an example flow chart of a method 400, in accordance with an example embodiment.

At optional operation 401, the client device 200 may receive an indication of a number of OFDM symbols to add in the adjusting of operation 406, e.g., via an RRC parameter, via a MAC CE, or via DCI, from a network node device.

At optional operation 402, alternative to or in addition to operation 401, the client device 200 may determine a number of OFDM symbols to add in the adjusting of operation 406 based on a number of PRBs.

At optional operation 403, alternative to or in addition to operation 401 and/or operation 402, the client device 200 may determine a number of OFDM symbols to add in the adjusting of operation 406 as a smallest number such that encoded UCI fits in a PUCCH resource.

At optional operation 404, alternative to or in addition to operation 401 and/or operation 402 and/or operation 403, the client device 200 may determine a number of additional PUCCH repetitions for use in the adjusting of operation 406 based on a second repetition factor indicated via at least one of an RRC parameter, a MAC CE, or DCI or a number of the additional PUCCH repetitions indicated via at least one of an RRC parameter, a MAC CE, or DCI, from a network node device.

At operation 405, the client device 200 detects a first PUCCH transmission and a parallel UL transmission.

At operation 406, the client device 200 adjusts, in response to the detecting, at least one parameter of a PUCCH resource, the at least one parameter being related to time domain allocation and/or frequency domain allocation for the first PUCCH transmission. As discussed in more detail in connection with FIG. 2A, the adjusting of the at least one parameter of the PUCCH resource may comprise, e.g., increasing a number of OFDM symbols of the PUCCH resource (based on, e.g., information obtained in operation 401 and/or 402), reducing a number of PRBs per an OFDM symbol to be equal to a predetermined PRB threshold and optionally increasing the number of OFDM symbols of the PUCCH resource (based on, e.g., information obtained in operation 403), adjusting the at least one parameter of the PUCCH resource based on a resource of the parallel UL transmission, and/or enabling at least one additional PUCCH repetition (based on, e.g., information obtained in operation 404).

The method 400 may be performed by the client device 200 of FIG. 2A. The operations 401-406 can, for example, be performed by the at least one processor 202 and the at least one memory 204. Further features of the method 400 directly result from the functionalities and parameters of the client device 200, and thus are not repeated here. The method 400 can be performed by computer program (s).

FIG. 2B is a block diagram of a network node device 210, in accordance with an example embodiment.

The network node device 210 comprises at least one processor 212 and at least one memory 214 including computer program code. The network node device 210 may also include other elements, such as a transceiver configured to enable the network node device 210 to transmit and/or receive information to/from other devices, as well as other elements not shown in FIG. 2B. In one example, the network node device 210 may use the transceiver to transmit or receive signaling information and data in accordance with at least one cellular communication protocol. The transceiver may be configured to provide at least one wireless radio connection, such as for example a 3GPP mobile broadband connection (e.g., 5G). The transceiver may comprise, or be configured to be coupled to, at least one antenna to transmit and/or receive radio frequency signals.

Although the network node device 210 is depicted to include only one processor 212, the network node device 210 may include more processors. In an embodiment, the memory 214 is capable of storing instructions, such as an operating system and/or various applications. Furthermore, the memory 214 may include a storage that may be used to store, e.g., at least some of the information and data used in the disclosed embodiments.

Furthermore, the processor 212 is capable of executing the stored instructions. In an embodiment, the processor 212 may be embodied as a multi-core processor, a single core processor, or a combination of one or more multi-core processors and one or more single core processors. For example, the processor 212 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 212 may be configured to execute hard-coded functionality. In an embodiment, the processor 212 is embodied as an executor of software instructions, wherein the instructions may specifically configure the processor 212 to perform the algorithms and/or operations described herein when the instructions are executed.

The memory 214 may be embodied as one or more volatile memory devices, one or more non-volatile memory devices, and/or a combination of one or more volatile memory devices and non-volatile memory devices. For example, the memory 214 may be embodied as semiconductor memories (such as mask ROM, PROM (programmable ROM), EPROM (erasable PROM), flash ROM, RAM (random access memory), etc.).

The network node device 210 may comprise a base station. The base station may include, e.g., a fifth-generation base station (gNB) or any such device providing an air interface for client devices to connect to the wireless network via wireless transmissions.

The at least one memory 214 and the computer program code are configured to, with the at least one processor 212, cause the network node device 210 to at least perform determining a number of orthogonal frequency-division multiplexing, OFDM, symbols for the client device 200 to add when adjusting at least one parameter of a physical uplink control channel, PUCCH, resource.

The at least one memory 214 and the computer program code are further configured to, with the at least one processor 212, cause the network node device 210 to perform transmitting to the client device 200 an indication of the number of the OFDM symbols to add via at least one of a radio resource control, RRC, parameter, a medium access control, MAC, control element, CE, or downlink control information, DCI.

Further features of the network node device 210 directly result from the functionalities and parameters of the client device 200 and thus are not repeated here.

FIG. 5 illustrates an example flow chart of a method 500, in accordance with an example embodiment.

At operation 501, the network node device 210 determines a number of orthogonal frequency-division multiplexing, OFDM, symbols for the client device 200 to add when adjusting at least one parameter of a physical uplink control channel, PUCCH, resource.

At operation 502, the network node device 210 transmits to the client device 200 an indication of the number of the OFDM symbols to add via at least one of a radio resource control, RRC, parameter, a medium access control, MAC, control element, CE, or downlink control information, DCI.

The method 500 may be performed by the network node device 210 of FIG. 2B. The operations 501-502 can, for example, be performed by the at least one processor 212 and the at least one memory 214. Further features result of the method 500 directly from the functionalities and parameters of the network node device 210, and thus are not repeated here. The method 5400 can be performed by computer program (s).

At least some of the embodiments described herein may allow avoiding the negative impact from a potential PUCCH power reduction, e.g., due to parallel PUCCH and other UL transmissions (such as PUSCH, SRS, another PUCCH, or PRACH).

At least some of the embodiments described herein may allow enhancing reliability and correct reception of PUCCH in case of parallel UL transmissions.

At least some of the embodiments described herein may provide help in case of limited coverage as well as MPE events.

At least some of the embodiments described herein may allow low complexity.

The client device 200 may comprise means for performing at least one method described herein. In one example, the means may comprise the at least one processor 202, and the at least one memory 204 including program code configured to, when executed by the at least one processor, cause the client device 200 to perform the method.

The network node device 210 may comprise means for performing at least one method described herein. In one example, the means may comprise the at least one processor 212, and the at least one memory 214 including program code configured to, when executed by the at least one processor, cause the network node device 210 to perform the method.

The functionality described herein can be performed, at least in part, by one or more computer program product components such as software components. According to an embodiment, the client device 200 and/or the network node device 210 may comprise a processor configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (GPUS).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1-18. (canceled)

19. A client device, comprising:
at least one processor;
at least one memory including computer program code;
the at least one memory and the computer program code configured to, with the at least one processor, cause the client device to at least perform:
detecting a first physical uplink control channel, PUCCH, transmission and a parallel uplink, UL, transmission; and
in response to the detecting, adjusting at least one parameter of a PUCCH resource, the at least one parameter being related to at least one of time domain allocation or frequency domain allocation for the first PUCCH transmission.

20. The client device according to claim 19, wherein the parallel UL transmission comprises one of a physical uplink shared channel, PUSCH, transmission, a second PUCCH transmission, a sounding reference signal, SRS, transmission, or a physical random access channel, PRACH, transmission.

21. The client device according to claim 19, wherein the adjusting of the at least one parameter of the PUCCH resource comprises increasing a number of orthogonal frequency-division multiplexing, OFDM, symbols of the PUCCH resource.

22. The client device according to claim 21, wherein the increasing of the number of OFDM symbols of the PUCCH resource comprises adding a number of OFDM symbols, and the at least one memory and the computer program code are further configured to, with the at least one processor, cause the client device to perform receiving an indication of the number of the OFDM symbols to add via at least one of a radio resource control, RRC, parameter, a medium access control, MAC, control element, CE, or downlink control information, DCI.

23. The client device according to claim 22, wherein the DCI comprises a DCI scheduling the parallel UL transmission.

24. The client device according to claim 21, wherein the increasing of the number of OFDM symbols of the PUCCH resource comprises adding a number of OFDM symbols, and the at least one memory and the computer program code are further configured to, with the at least one processor, cause the client device to perform determining the number of the OFDM symbols to add based on a number of physical resource blocks, PRBs.

25. The client device according to claim 19, wherein the adjusting of the at least one parameter of the PUCCH resource comprises reducing a number of PRBs per OFDM symbol.

26. The client device according to claim 25, wherein the reducing of the number of the PRBs per OFDM symbol comprises reducing the number of the PRBs per OFDM symbol to be equal to a predetermined PRB threshold.

27. The client device according to claim 25, wherein the adjusting of the at least one parameter of the PUCCH resource further comprises increasing a number of OFDM symbols of the PUCCH resource by adding a number of OFDM symbols, and the at least one memory and the computer program code are further configured to, with the at least one processor, cause the client device to perform determining the number of the OFDM symbols to add as a smallest number such that encoded uplink control information, UCI, fits in the PUCCH resource.

28. The client device according to claim 19, wherein the adjusting of the at least one parameter of the PUCCH resource comprises adjusting the at least one parameter of the PUCCH resource based on a resource of the parallel UL transmission by adjusting the at least one parameter of the PUCCH resource so that time domain allocation of the PUCCH resource and time domain allocation of the resource of the parallel UL transmission have at least one of a starting symbol or an ending symbol aligned.

29. The client device according to claim 19, wherein the adjusting of the at least one parameter of the PUCCH resource comprises enabling at least one additional PUCCH repetition by overriding a first repetition factor for the PUCCH resource.

30. The client device according to claim 29, wherein the at least one memory and the computer program code are further configured to, with the at least one processor, cause the client device to perform determining the number of additional PUCCH repetitions based on a second repetition factor indicated via at least one of an RRC parameter, a MAC CE, or DCI, or based on a number of the additional PUCCH repetitions indicated via at least one of an RRC parameter, a MAC CE, or DCI.

31. The client device according to claim 19, wherein the parallel UL transmission comprises at least one of: a UL transmission in a same serving cell or same bandwidth part as the first PUCCH transmission, a UL transmission at least partially overlapping in time with the first PUCCH transmission, or a UL transmission from a different transmit antenna panel than the first PUCCH transmission.

32. A method, comprising:
detecting, by a client device, a first physical uplink control channel, PUCCH, transmission and a parallel uplink, UL, transmission; and
in response to the detecting, adjusting, by the client device, at least one parameter of a PUCCH resource, the at least one parameter being related to at least one of time domain allocation or frequency domain allocation for the first PUCCH transmission.

33. A network node device, comprising:
at least one processor; and
at least one memory including computer program code;
the at least one memory and the computer program code configured to, with the at least one processor, cause the network node device to at least perform:
determining a number of orthogonal frequency-division multiplexing, OFDM, symbols for a client device to add when adjusting at least one parameter of a physical uplink control channel, PUCCH, resource; and
transmitting to the client device an indication of the number of the OFDM symbols to add via at least one of a radio resource control, RRC, parameter, a medium access control, MAC, control element, CE, or downlink control information, DCI.
